(19) United States
(12) Patent Application Publication
(10) Pub. No.: US 2016/0243793 A1
(43) Pub. Date: Aug. 25, 2016

(54) PRESSURE-SENSITIVE ADHESIVE AND PRODUCTS

(71) Applicant: Carlisle Intangible Company, Syracuse, NY (US)

(72) Inventor: Jesse Alvin Binkley, Midlothian, TX (US)

(21) Appl. No.: 15/143,660

(22) Filed: May 2, 2016

Related U.S. Application Data
(62) Division of application No. 12/651,546, filed on Jan. 4, 2010, now abandoned.

(51) Int. Cl. B32B 7/12; B32B 5/22

(52) U.S. Cl. CPC B32B 7/12; B32B 5/22; B32B 2395/00; B32B 2255/26; B32B 2405/00; B32B 2260/046

(57) ABSTRACT

An asphalt base pressure-sensitive adhesive includes asphalt, an elastomer, residual pitch, as well as isoflour and optional oil and other inert fillers. The amount of elastomer is reduced by incorporating the residual pitch product which acts as an extender of the elastomer. Further, the isoflour further acts as an extender, and is compatible with the residual pitch. In a preferred embodiment, the pitch product is pine pitch.

### CROSS-REFERENCE TO RELATED APPLICATIONS

This application is a division of U.S. patent application Ser. No. 12/651,546 filed Jan. 4, 2010, the disclosure of which is expressly incorporated by reference herein in its entirety.

### FIELD OF THE INVENTION

The present invention relates to pressure-sensitive adhesives and more particularly to products incorporating a pressure-sensitive adhesive layer to form peel-and-stick products for exterior applications.

### BACKGROUND OF THE INVENTION

There are a wide variety of products that protect the exterior of a building, particularly from water ingress. These can include subterranean waterproofing products as well as roofing products. For ease of application, many prefer self adhesive or pressure-sensitive adhesive products. Such products must meet end-use requirements and, further, must be cost competitive with more traditional coating compositions. Asphalt formulations, particularly those incorporating a thermoplastic elastomer, have been used to form coating compositions.

In such formulations, the rubber is the most expensive component, but is necessary to provide flexibility, particularly at lower temperatures.

Any such pressure-sensitive adhesive for use in exterior applications must have good tack at application temperature. And must have a reasonably high melting point so that it does not flow at higher temperatures, such as those typically encountered on a roof surface. These can be 190 to 200° F., or even higher in certain applications.

Any such product must also remain flexible at relatively low temperatures and must have a certain amount of flow at moderate temperatures so a water tight seal would be formed around a penetration, such as that which might be caused by a nail penetrating the product.

Finally, any pressure sensitive adhesive must have a high peel strength at set.

### SUMMARY OF THE INVENTION

The present invention is premised on the realization that an asphalt/thermoplastic elastomer pressure-sensitive adhesive can be formed wherein the concentration of the rubber is minimized by incorporating a pitch product, such as pine pitch, with acceptable fillers to provide a pressure-sensitive adhesive with reduced elastomer concentration. The fillers may include ground polymeric foam which acts as a low-density filler and also permits the reduction of the elastomer concentration. Other optional components include inorganic fillers as well as oil.

Further, this pressure-sensitive adhesive can form a coating on a substrate which can be used with a release coating to provide a peel-and-stick product suitable for exterior applications. For example, the substrate may be a waterproof membrane or a gravel coating and the product can be used on a roof surface or the side of a building.

The objects and advantages of the present invention will be further appreciated in light of the following detailed descriptions and drawings in which:

### BRIEF DESCRIPTION OF THE DRAWING

FIG. 1 is a cross sectional view of a peel-and-stick product according to the present invention;

FIG. 2 is a cross sectional view of an alternate embodiment of the present invention.

### DETAILED DESCRIPTION

A pressure-sensitive adhesive according to the present invention incorporates asphalt, a thermoplastic elastomer, and a pitch component. Further, the composition can include ground foam, oil, and an inorganic filler material.

Generally, any suitable asphalt may be incorporated into the pressure sensitive adhesive. As is known in the art, asphalt may be obtained from naturally occurring sources or as one of the cuts during distillation of petroleum. As such, the composition of asphalt may vary by refining source and by petroleum source. Furthermore, the asphalt may be oxidized as is known in the art.

The asphalt must be compatible with the rubber that is selected, and must be tacky at the application temperature. Thus, it cannot be an extremely hard asphalt.

Asphalt generally contains various fractions of hydrocarbons, such as polycyclic hydrocarbons, and may also contain some polar elements. Asphalt generally has a softening point of between about 85° F. and about 200° F., but the softening point may be higher depending on the petroleum source and the various hydrocarbon fractions. The penetration of the asphalt may be between about 5 and about 300 decimillimeters at 77° F. with a 100 g load applied for 5 seconds, but is preferably about 180 decimillimeters.

Asphalt is also graded by its rheological properties, for example, by its viscosity. The asphalt viscosity will generally be between about 200 and 3000 poises at 140° F. The asphalt may be AC-3, AC-5, AC-7.5, AC-10, AC-20, and AC-30. However, higher viscosity asphalts may be utilized in certain applications. Asphalts are available from Owens Corning, Toledo, Ohio; Valero, San Antonio, Tex.; Marathon, Houston, Tex.; and ConocoPhillips, Houston, Tex.

The elastomer provides a polymeric network that provides elongation and recovery to the adhesive. Further, it provides resistance to flow as long as the temperature does not reach the melting point of the elastomer. The elastomer also provides low temperature flexibility.

The elastomeric material may be any thermoplastic material that provides sufficient elastomeric-type, or non-linear elasticity to the adhesive composition.

Suitable polymeric materials may include styrene-butadiene-styrene (SBS), styrene-butadiene, styrene-ethylene/butylene-styrene (SEBS), styrene-isoprene-styrene (SIS), ethylene propylene diene M-class (EPDM) rubber, and polyamides. These polymeric materials are commercially available from Kraton of Houston, Tex.; LCY Elastomers LP of Baytown, Tex.; and Arizona Chemical of Jacksonville, Fla.

Other suitable commercially available elastomeric materials include, SOLPRENE® 411 high molecular weight radial styrene-butadiene block copolymer, SOLPRENE® 4318 linear block copolymer, and SOLPRENE® 1205 linear random-block styrene-butadiene copolymer, each available from Dynasol of Houston, Tex.

Residual pitch products are by-products of processing plant material generally including a blend of fatty acids, esterified fatty acids, resin acids, and unsaponifiables. For instance, in one embodiment, the residual pitch product is a distillate of a by-product of a wood pulping process for making paper, which may contain various resin and fatty acids. Specifically, the residual pitch product may appear as a dark soft solid and may contain about 25 wt. % fatty acids and esterified acids, about 25 wt. % rosin acids, and unsaponifiables of about 7 wt. %.

The residual pitch product should have a lower softening point and a lower glass transition temperature than the asphalt. The residual pitch product can be pine pitch residue produced by heating resin obtained from conifers, which may contain resin acids. The residual pitch product may also be a tall oil rosin derivative, sometimes referred to as tall oil pitch or bottoms, or products from tall oil fractionation. Products from tall oil fractionation generally contain at least about 91 wt. % fatty acids, a maximum of about 3.0 wt. % rosin acids, and unsaponifiables of up to about 3 wt. %.

Residual pitch products are commercially available from, for example, Arizona Chemical, Jacksonville, Fla., such as SYLFAT® DP-8 residual pitch product. Tall oil derivatives are also commercially available, such as TALLEX® tall oil derivative from Meadwestvaco Corporation, Stamford, Conn.; and XTOL® and LYTOR® tall oil derivatives sold by Georgia-Pacific Chemicals LLC, Atlanta, Ga.

The pressure sensitive adhesive preferably includes an amount of isoflour which acts as a filler and further as a rubber extender, and is particularly compatible with the asphalt and the thermoplastic elastomer. The term “isoflour” specifically references ground polymeric rigid foam material wherein the polymer is either a polyisocyanurate or a polyisocyanate. This product may be obtained by simply grinding waste polyisocyanate or polyisocyanurate rigid foam insulation. Ground isocyanurate foam having the following particle size distribution worked well:

0.55% was stopped by the #12 screen;

22.25% was stopped by the #40 screen;

43.65% was stopped by the #100 screen; and

33.5% passed through the final screen.

A second filler material may also be added. This filler material is a solid inert particulate material. The average particle size of the filler material may vary and may depend upon the composition of the filler material, its cost for different average particle sizes of the filler material, and the application for which the sealant composition is made. Generally, as the average particle size is reduced, the viscosity of the adhesive composition increases. The inverse is also true, that is, as the average particle size is increased the viscosity is reduced. The average particle size may be less than about 50 μm and is more often less than about 25 μm. The average particle size is usually greater than about 0.5 μm, and it may be greater than about 0.8 μm, to reduce dusting during manufacturing.

Specific fillers include ceramic microspheres, glass beads (either hollow or solid), calcium carbonate, mica, talc, or gypsum or a combination thereof. Other suitable materials include granite, volcanic ash, barium sulfate, and ground-up rubber and/or plastic. By way of example, calcium carbonate powder is available from Huber Engineered Materials, Atlanta, Ga., under the trademark HUBERCARB® G Series calcium carbonate. One product, HUBERCARB® G 325 calcium carbonate powder, has a mean particle size of 10.5 μm, a weight per gallon of 22.6 lbs/solid gallon, and a particle size screen analysis of 100% passing through a 100 mesh screen, 99.9% passing through a 200 mesh screen, and 99% passing through a 325 mesh screen.

The inert filler may also be recycled material such as ground tire, or other ground plastics such as PET.

As set forth above, the composition may further include an oil. Addition of the elastomer can act to reduce the tack. The oil can be added to restore the tack. Also, the oil acts to lower the softening point and lower the working viscosity of the product. One exemplary oil is naphthenic oil. Generally, naphthenic oils are classified as having less than about 60% paraffinic carbon and are often characterized by the ability to flow at low temperatures, unlike paraffinic oils. Naphthenic oils are available commercially, for example, from Ergon Refining, Inc. Jackson, Miss., sold under the tradename Hyprene, such as Hyprene L500, and another commercial source of oil includes Sunoco, Philadelphia, Pa.

The pressure sensitive adhesive requires good low temperature characteristics. These low temperature characteristics can be measured by using the ASTM D-1970 method. Preferably, the adhesive will bend around a 1-inch mandrel with a 90° turn in less than 2 seconds at −25° F. The tack of the adhesive at 78° should be greater than or equal to 0.4 and, preferably, greater than or equal to 1. At 40° F., the tack should be greater than 0.2 and, preferably, greater than 0.4.

When used as a roofing product, the softening point of the adhesive should be greater than 190° F. Generally, it will be greater than 200° F., and, for some applications, the adhesive will be formulated to have a softening point greater than 260° F.

The primary component of the present invention will be the asphalt which is modified with the elastomer. The amount of elastomeric material added should be sufficient to provide a continuous network of the elastomeric molecules or at least sufficient to position the molecules of elastomeric materials sufficiently close to one another within the sealing composition to provide a measurable improvement of the flexibility of the sealant composition.

Generally, the adhesive composition will have 0.5-15 percent by weight of the elastomeric material. Since the elastomeric material is the most expensive component, it is desirable to minimize this content without adversely affecting the physical characteristics of the adhesive. In certain formulations, the content will be from 2 to about 13%, and in precise formulations may be from 5 to 10%.

The residual pitch product acts as a rubber extender when added to the asphalt. It markedly increases the flexibility and at the same time it reduces the tack. Therefore, the addition of the pitch allows one to decrease the rubber content. Generally, there will be from about 0.5% to 25% pitch. In certain formulations, this will be from 2-20% by weight with a narrower limit of 3-6%. The pitch also allows the reduction of peak temperature during rubber milling, from 370° F. to about 350° F., thus reducing the temperature degradation of the rubber.

The isoflour acts as a unique filler that is low density thereby extending the coating matrix without increasing the product weight. It also acts as a rubber extender that allows a reduction in the rubber content. This increases the softening point of the product without an increase in the rubber content. Thus, the amount of isoflour can be zero percent, but will generally be 0.5-25%. In certain formulations, it will be 1-15% by weight, and, in other formulations, 2.5-7.5% by weight.

In addition to the isoflour, other inert fillers can be used to extend the product and decrease the cost of the product. Generally, these would be present about 0-50% with 10-20% being used in certain formulations.

Likewise, the oil is an optional component in the present invention and it can be present in an amount from about 0-12% by weight, generally 3-12%. The balance of the formulation will then be the asphalt.

To formulate the adhesive composition, the residual pitch product and asphalt are heated to a temperature sufficient to reduce their viscosity and are mixed together. Generally, the mixing temperature will be from about 350° F. to 370° F. High shear mixing is used to blend the elastomeric material into a residual pitch product and asphalt mixture. Once the elastomeric material is mixed into the residual pitch product/asphalt mixture, the isoflour and inert filler are added. Additional gentle agitation may be used to thoroughly mix the filler into the mixture at the same time, any oil or other components are added.

A typical formulation can have the following components.

TABLE

| | |
|---|---|
| Asphalt | 63.23% |
| Pine Pitch | 4.83% |
| Iso-flour | 3.00% |
| SBS | 4.83% |
| Oil | 8.09% |
| Calcium Carbonate | 16.02% |

This product had a softening point of 229° F. Typically, an asphalt formulation with such a softening point would require 7-7.5% elastomerics in order to pass a cold bend test at −25° F.

The adhesive composition of the present invention can be formed into a film-like structure, either on a separate substrate, or coated with a substrate and then covered with a separate release sheet.

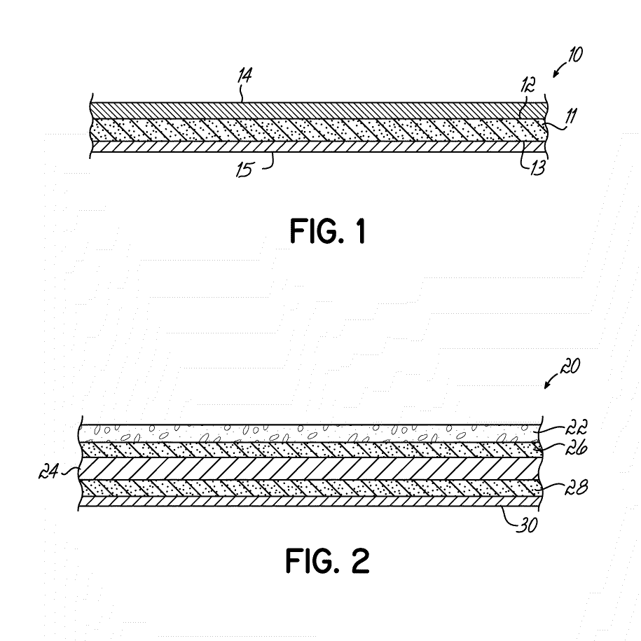

As shown in FIG. 1, a pressure-sensitive adhesive laminate 10 includes an intermediate pressure sensitive adhesive layer 11 that has a first side 12 and a second side 13. The second side 13 is adhered to a non-tacky layer 14. The non-tacky layer can be, for example, a polymeric membrane such as a EPDM, PVC, thermoplastic elastomer, or any membrane suitable for exterior applications. The upper layer can be a wide variety of different materials, including single ply polymeric films, laminated polymeric films, woven webs, nonwoven webs, laminations of woven and nonwoven webs, as well as thicker products such as mats of ground rubber, or even a non-tacky asphaltic surface. In turn, the first surface 12 is covered with a release sheet 15, preferably one with a silicone coating contacting the surface 12. Generally, the pressure sensitive adhesive layer will have a thickness of 20 to about 60 mils. This laminate can be applied to a building surface such as a roof or wall by removing the release sheet and pressing the adhesive layer against the surface.

The laminate 10 is formed by coating layer 14 with a molten layer of the adhesive 11 using a curtain coater. The thickness is established with a knife or calendar rollers. The adhesive is cooled under controlled circumstances and a release sheet 15 applied to the opposite side 12.

As shown in FIG. 2, a laminate 20 with an upper layer 21 of a particulate material can be formed by first saturating a fiberglass mat 24 with a molten solution of the pressure sensitive adhesive. This forms upper and lower layers 26,28 of the pressure sensitive adhesive. Typically, this will be done in a bath at a temperature of 300 to 370° F. The impregnated mat 24 can then be run through a calendaring roll to establish the desired thickness, and, subsequently cooled. A sand layer 22 is applied to upper layer 26 of the adhesive-impregnated mat, and a release layer 30 applied to the lower layer 28. This can then be wound up. Generally, the thickness of the lower layer will be 40 to 60 mils. This laminate 20 can be applied to a building surface by removing the release layer 30 and pressing adhesive layer 28 against the building surface.

This structure can be used in a variety of external applications. It can be applied to a roof structure as either a sealing layer or a protective layer, such as a walkway pad on a membrane roof.

This has been a description of the present invention along with the preferred method of practicing the present invention. However, the invention itself should only be defined by the appended claims, WHEREIN I CLAIM:

What is claimed is:

1. A laminate comprising:
a layer of a pressure sensitive adhesive having a first surface and second surface; and
a non-tacky covering layer on said first surface and comprising gravel embedded in said first surface,
wherein said pressure sensitive adhesive comprises:
0.5 to 15% by weight of a thermoplastic elastomer;
0.5 to 25% by weight residual pitch; and
asphalt, and
wherein said pressure sensitive adhesive has low temperature flexibility and tack at an application temperature.

2. The laminate of claim 1 further comprising 10-50% by weight inert filler.

3. The laminate of claim 1 further comprising 0.5 to 25% by weight of isoflour.

4. The laminate of claim 1 further comprising 3-12% by weight oil.

5. The laminate of claim 1 wherein said residual pitch comprises pine pitch.

6. The laminate of claim 1 further comprising an intermediate fibrous layer impregnated with said pressure sensitive adhesive.

7. The laminate of claim 1 wherein said pressure sensitive adhesive layer has a thickness of 20 to about 60 mils.

8. The laminate of claim 1 wherein said pressure sensitive adhesive will bend around a 1 inch madrel with a 90° turn in less than 2 seconds at −25° F.

9. The laminate of claim 1 wherein said pressure sensitive adhesive has a tack of equal to or greater than 0.4 at 78° F.
